(19) United States
(12) Patent Application Publication
(10) Pub. No.: US 2025/0128534 A1
(43) Pub. Date: Apr. 24, 2025

(54) Systems and Methods of Permanently Marking Polymeric Materials

(71) Applicant: Chris Chemberlen, Santa Ana, CA (US)

(72) Inventor: Chris Chemberlen, Santa Ana, CA (US)

(21) Appl. No.: 18/936,677

(22) Filed: Nov. 4, 2024

Related U.S. Application Data
(63) Continuation-in-part of application No. 17/168,879, filed on Feb. 5, 2021, now Pat. No. 12,134,142.

(51) Int. Cl. B41M 5/26; B41J 2/44; B41J 3/01; B41J 29/377; B41M 5/46; B65B 61/02; C08J 7/12; G06K 19/06

(52) U.S. Cl. CPC B41M 5/267; B41J 2/442; B41J 3/01; B41J 29/377; B41M 5/465; B65B 61/025; C08J 7/123; G06K 19/06037; C08J 2323/06

(57) ABSTRACT

Systems and methods of permanently marking a material containing an opacification material may include marking the material with a laser system. The laser system may be an ultraviolet system, and the laser may be a solid state diode pumped and pulsed 4 watt to 55 watt unit with a minimum scan speed of 3 meters/second and a minimum frequency of 30 KHz.

### REFERENCE TO RELATED APPLICATIONS

This nonprovisional patent application is a continuation-in-part of nonprovisional patent application U.S. Ser. No. 17/168,879 (filed Feb. 5, 2021) which includes an Appendix (GSI DataMatrix Guideline Release 2.5.1, Ratified, January 2018). In addition, U.S. Ser. No. 17/168,879 is based on provisional patent application, U.S. Ser. No. 62/971,829 (filed February 7, 2020). The priority of U.S. Ser. No. 17/168,879 (filed Feb. 5, 2021) and U.S. Ser. No. 62/971,829 (filed Feb. 7, 2020) are both claimed for priority purposes pursuant to 35 USC § 120.

### FIELD

Embodiments of the present subject matter, as described herein, relate in general to placement of permanent marks on materials, and more particularly, to systems and methods of permanently marking polymeric materials containing opacification materials.

### BACKGROUND

Using UV lasers to print on plastic substrates is well known. For example, US U.S. Pat. No. 7,837,823 to Griffin et al. is directed to a multi-layer laminate plastic layer media, on which information may be applied in machine or human readable form on a visible front surface by an output of one or more lasers, or other high intensity light source. In a preferred embodiment, media has three layers including a substrate, a thermochromic layer and a light absorbent layer such as carbon black located between a media substrate and the thermochromic layer. The light absorbent layer is adapted to absorb light from the light source and convert the absorbed light into heat. Heat thus produced is immediately conducted into selected portions of the thermochromic layer which is in thermal contact with the light absorbent layer, thereby causing portions of thermochromic layers to change visual appearance, e.g., color to create a desired mark. The disclosure also involves a method and apparatus for using media in conjunction with the labeling of product items.

U.S. Pat. No. 6,160,835 to Kwon discloses a hand-held marker with dual output laser.

U.S. Pat. No. 7,771,646 to Clauss et al. discloses laser-markable compositions that include at least one semicrystalline thermoplastic and at least one particulate additive selected from the group consisting of (1) a light-sensitive salt compound, (2) an inorganic oxide having an average particle diameter of less than 250 nm, and (3) combinations thereof. U.S. Pat. Nos. 9,662,833 and 10,639,851 (both to Ferrell et al.) are each directed to marked thermoplastic compositions as well as to an article used for laser marking. The article comprises: a thermoplastic polymer, an active component comprising at least one of a polymeric unit and an additive. The thermoplastic polymer has a visible transmission of greater than or equal to 80% according to ASTM D1003-00, Procedure A, using D65 illumination, and a thickness of about 1 mm. The thermoplastic polymer includes a mark produced by the chemical rearrangement of the active component generated by a laser of a first wavelength. The mark exhibits at least one of: (1) a change in optical properties in the region 400 nm to 700 nm when exposed to light having a wavelength less than or equal to 500 nm; and (2) a change in optical properties in the region of 400 nm to 700 nm when exposed to light having a wavelength greater than or equal to the first wavelength.

U.S. Pat. No. 11,198,769 to Pudleiner et al. discloses plastic films alleged to have improved laser engraving capability, chemical resistance, and mechanical stress. Special embodiments of such films, in the form of co-extrusion films, are disclosed. Also disclosed are layered structures comprising such films. Also disclosed are uses of such films, as security documents, including personal identification documents, that contain such films.

U.S. Pat. No. 11,242,464 to Tziovaras et al. is directed to a so-called improved method for partial coloring, in particular, colored-laser engraving of various plastic parts, including thermoplastic parts, which comprise a layered structure, and to the resulting partially colored, in particular, variously colored and laser-engraved plastic parts, including said thermoplastic parts. U.S. Pat. No. 11,306,215 to DeMeutter discloses UV-curable inkjet inks.

U.S. Pat. No. 10,305,252 to Muendel et al. discloses a laser system as well as a method of tuning the output power of the laser system. U.S. Pat. No. 10,752,534 to Nieber et al. discloses apparatuses and methods for laser-processing laminate workpiece stacks.

U.S. Pat. No. 9,102,007 to Hosseini discloses systems and methods for forming continuous laser filaments in transparent materials. In the systems and methods, a burst of ultrafast laser pulses is focused so that a beam waist is formed external to the material being processed without forming an external plasma channel, while a sufficient energy density is formed within an extended region within the processed material to support formation of a continuous filament, without causing optical breakdown in the material. Filaments formed according to the method may have lengths that are greater than 10 mm.

U.S. Pat. No. 8,865,379 to Sharpe et al. discloses polymeric members and laser marking methods for producing visible marks on the polymeric members, which includes producing visible marks on the thin and/or the curved surfaces of the polymeric members.

U.S. Pat. No. 7,705,268 to Gu et al. discloses methods and systems for laser soft marking, especially for laser soft marking semiconductor wafers and devices. A laser marking system for marking a semiconductor wafer to form a soft mark on the wafer is provided. The system includes a laser subsystem for generating one or more laser pulses and a controller operatively connected to the laser subsystem. The controller sets a laser pulse width of the one or more laser pulses to selectively provide one or more laser output pulses having one or more set pulse widths that affect the depth of a soft mark that is to be formed. The mark depth is substantially dependent on the one or more set pulse widths. The controller further sets a pulse energy of the one or more output pulses to selectively provide the one or more output pulses having a set total output energy that is within a predetermined acceptable process energy window for producing the soft mark.

U.S. Pat. No. 6,592,949 to Polke et al. discloses methods of marking plastic surfaces by: (1) applying a composition comprising at least one coloring component to a plastics surface, and (2) irradiating the plastics surface with light from a light source. U.S. Pat. No. 8,464,711 to Howarth et al. discloses an obscuration means comprising a variable obscuration layer by which a thermochromic affect is achieved through varying its degree of obscuration. For example, a layer may be translucent in the absence of applied heat, and applied heat conducted from a light-absorbent layer causes it to become opaque, e.g., by formation of gas bubbles within a polymer matrix, obscuring the absorbent layer. Or, the obscuration layer may have an opaque status in the absence of heat, and later conduction of heat from the light-absorbent layer makes the obscuration layer translucent.

One aspect of the present subject matter is the recognition that it would be desirable to place permanent markings on certain materials, such as polymer materials, particularly those that include an opacification material, including but not limited to titanium dioxide. It would be particularly desirable to mark such materials with clarity, without damaging the material, at a speed great enough to allow to mark complete and multiple package labels, preferably with associated barcodes, to allow for serialization marks for identifying package position within a continuous packaging run of a product lot.

Therefore, systems and methods capable of providing multiple lines of marks on such materials at a suitably fast rate without compromising the mark integrity are desired.

### SUMMARY

Embodiments of the present subject matter are directed to systems and methods for permanently marking a variety of polymeric materials containing effective amounts of select opacification and/or non-opacification materials, by using a select ultraviolet (UV) laser equipped with a high-speed scanning (Galvanometer) system and large field optics (e.g., up to 600 mm×600 mm), without causing damage to the various polymeric substrate materials. The systems and methods of the present subject matter, thus, may include marking these materials with a preselected laser system. In some instances, the laser system selected may be a 355±0.1 nm ultraviolet (“UV”) system, and the laser may be a diode-pumped solid state and pulsed 4-watt to 55-watt unit with a minimum scan speed of 3 meters/second and a minimum pulse frequency of 30 KHz. In other applications, for example with other materials, other laser systems may be used including but not limited to 355±0.5 nm, 355±1 nm, 355±2 nm, 355±3 nm, 355±4 nm, or 355±5 nm systems.

In systems of the present subject matter, a packaging machine may comprise a conveyorized linear or rotary system to feed pre-cut individual or grouped packaging material components (i.e., paper, chipboard, film, foil-lidding materials, pre-fabricated paper, or foil-pouch materials (3-side sealed or other), and pre-cut polymer or composite “product retention” materials) in communication with the laser and inspection systems, either on demand or for a designated number of cycles. The packaging machine, laser printing, inspection system can be configured to feed select components to the laser system for marking, on receiving a signal from the laser system. Packaging machines equipped with laser mark-inspection systems are adapted to inspect marked contents of individual components for compliance with an approved acceptance specification. Upon receiving a signal from the inspection system, the packaging machine will deliver the marked packaging materials either to a “defect” station or an “accepted product” station.

An additional feature of the identified marking system is its ability to place permanent marks without ablation of other markings, for complete package labels, in a large marking field when the system has been incorporated into a web fed intermittent or continuous motion packaging machine, and maintain, e.g., a 1-25 cycle per minute line speed. Applications of various other laser-marking technologies have been incorporated into conveyorized container lines, for purposes of marking so-called “lot codes” and/or “use by” product-dating information, along with barcodes, trademarks, and/or logos on products. While such systems and methods may be utilized to ablate pre-printed labels and/or print contrasting-ink colors onto substrates, to generate select codes or characters, the implementation of such systems and methods may not allow efficient and large-field marking, unless additional equipment is incorporated, which results in additional expense.

Various implementations of methods of permanently marking polymeric material containing an opacification material are provided. Such methods can include providing (1) polymeric material containing select opacification material and (2) a laser system. An embodiment of such a laser system may comprise a pulsed ultraviolet (“UV”) laser equipped with an average output power of 4 to 55 watts (“W”). Such methods can also include marking the polymeric material by using the laser system operating at a minimum scan speed of 3 meters per second and a minimum pulse frequency of about 30 KHz. The laser system may produce less than 10 microns of cratering in the polymeric material.

In implementations of the present subject matter, the laser system can comprise a 355±0.1 nm ultraviolet laser. Average output power of the laser system can, e.g., range from about 4 watts (“W”) to about 40 W, or from about 4 W to about 20 W, or from about 8 W to about 20 W. In certain instances, the scan speed can range, e.g., from about 3 meters/second to about 8 meters/second or from about 6 meters/second to about 8 meters/second. In certain instances, the pulse frequency may, e.g., range from about 30 kilohertz (“KHz”) to about 50 KHz. In many instances, the laser system produces less than about 7 microns of cratering in polymeric material, or less than about 5 microns, or less than about 3 microns, or less than about 1 micron of cratering in polymeric material. For various methods of the present subject matter, the laser system would be capable of marking up to 500 alphanumeric characters in about 8-point to 16-point font, to produce human-readable identification characters in polymeric material in about 3 to 5 seconds.

For methods of the present subject matter, a laser system can mark a 2D barcode in polymeric material. In certain cases, a 2D barcode can have a marking quality within an ISO/IEC 15415:2011 symbol grade of at least 2.0, 3.0, or 4.0 for an aperture, light, and angle or a February 2011 ANSI grade of at least “A”, “B”, or “C” pursuant to the 2015 2D Barcode Verification Process Implementation Guideline per GS1 Data Matrix Guideline Release 2.5.1, Ratified, January 2018. In some cases, a 2D barcode can meet the ISO/IEC 15415:2011 standards for one, some, or all the individual criteria of decode, symbol-contrast, axis-nonuniformity, grid-nonuniformity, unused-error-correction, fixed pattern damage, modulation, and print-growth. In certain cases, the 2D barcode can meet the May 19, 2015, American Standard AS 9132. In some cases, a 2D barcode can meet the standards for one, some, or all the individual criteria of number-of-dots per element, angle-of-elongation, center-point-discrepancy, distortion, filled-cells, and quiet zone. In certain instances, a 2D barcode can meet ISO/IEC TR 29158:2020 Direct Part Mark Quality Guideline. In some cases, a 2D barcode can meet ISO/IEC TR 29158:2020 standards for one, some, or all the individual criteria of modulation, axis-nonuniformity, symbol-contrast, grid-nonuniformity, fixed pattern damage, unused error correction, decode, and print growth. For situations, a 2D barcode can meet ISO/IEC TR 29158:2020 standards for individual criteria of modulation within a cell and/or a minimum reflectance.

In embodiments, polymeric material can include spun-bound polyolefin and/or hydro-entanglement-generated polyolefin fibrous sheeting. In embodiments, polymeric material can comprise high-density polyethylene. In embodiments, such material may be solid polymer sheeting. In embodiments, such material can include, and not be limited to, polystyrene, styrene-polycarbonate, polyethylene terephthalate, acrylonitrile butadiene styrene (“ABS”), thermo-plastic urethane (“TPU”) and/or polyvinyl chloride. In examples, opacification material can include a pigment, calcium carbonate, and/or titanium dioxide.

An assortment of system implementations designed, adapted and configured to permanently mark a material are provided. The system can include a laser system having a marking field. The system can also include a packaging machine in communication with the laser system. The packaging machine can be designed, adapted, and configured to hold a portion of the polymer material within the marking field of the laser system for a predetermined amount of time. Upon receiving a signal from a packaging machine, the laser system can be designed, adapted, and configured to mark the portion of the material within the marking field of the laser system within the predetermined amount of time. Upon receiving a signal from the laser system, the packaging machine can be designed, adapted, and configured to feed the marked portion out of the marking field of the laser system and feed a successive portion of the material into the marking field of the laser system. The laser system can be configured to mark the respective portion of the material and the packaging machine can be designed, adapted, and configured to feed the respective marked portion of the material out of the marking field of the laser system for a designated number of cycles. In some systems, the predetermined amount of time can be within 4 seconds and/or the number of cycles, for example, can range from 1 to about 12 cycles, or can be at least about 5 cycles, or can range from about 5 to about 15 cycles.

Various systems of the present subject matter can include a temperature control system. For example, such a temperature control system can be designed, adapted, and configured to include a liquid coolant chilling system to control laser system temperatures.

The laser system can comprise a pulsed ultraviolet (“UV”) laser with an average output power ranging from 4 W to about 55 W, a minimum scan speed of 3 meters/second, and a minimum pulse frequency of about 30 kilohertz (“KHz”). In certain cases, the laser system could comprise a 355±0.1 nm UV laser. Other laser systems could also be used.

### BRIEF DESCRIPTION OF THE DRAWING FIGURES

Having thus described the invention in general terms, reference is now made to the accompanying figures, which show different views of different example embodiments.

FIG. 1 is a plot of a Raman spectrum with intensity (in arbitrary units) on the vertical axis versus wavenumber (in reciprocal centimeters) on the horizontal axis, acquired from a white (unmarked) area of a laser-marked sheet of high-density polyethylene (“HDPE”).

FIG. 2 presents a copy of a microscope image of the laser-marked sheet of HDPE.

FIG. 3 is the plot shown in FIG. 1, overlaid with the spectrum of the HDPE sheet.

FIG. 4 is the plot depicted in FIG. 1, overlaid with the bands of TiO2 in rutile form.

FIG. 5 depicts a plot of the Raman spectrum acquired from a grey (marked) area of a laser-marked sheet of HDPE.

FIG. 6 is a microscope image of the laser marked sheet of HDPE shown in FIG. 5.

FIG. 7 depicts the plot of FIG. 5 overlaid with a portion of the plot shown in FIG. 1.

FIG. 8 presents a version of the plot of FIG. 7 depicted at the lower wavelengths.

FIG. 9 presents a reference spectrum of carbon black.

FIG. 10 is an example pair of package labels marked with an 8 W ultraviolet laser.

FIG. 11 is an example pair of package labels marked with a 20 W ultraviolet laser.

FIG. 12A shows an example laser marking generated with a 20 W ultraviolet laser.

FIG. 12B presents one of the four labels shown in FIG. 12A.

FIG. 12C presents one of four labels generated with an 8 W ultraviolet laser.

FIGS. 13A-13D present images of two marked sections of a laser-marked material using a 3 W laser.

FIGS. 14A-14B present the 500× images of the white and grey areas, respectively, of a laser-marked material using a 3 W ultraviolet laser.

FIGS. 15A-15B depict the 2000× images of the white and grey areas, respectively, of a laser-marked material using a 3 W ultraviolet laser.

FIGS. 16A-16B depict the 2000× images of the white and grey areas, respectively, of a laser-marked material using a 3 W ultraviolet laser.

FIGS. 17A-17B depict the 2000× images of the white and grey areas, respectively, of a laser-marked material using a 3 W ultraviolet laser.

FIGS. 18A-18B depict the 5000× images of the white and grey areas, respectively, of a laser-marked material using a 3 W ultraviolet laser.

FIG. 19 depicts the 5000× image of the grey area of a laser marked material using a 3 W ultraviolet laser.

FIGS. 20-22 depict comparative Fourier transform infrared (FTIR) spectroscopy spectra of two sections of the white material and two sections of the grey affected sections of the material using a 3 W ultraviolet laser.

FIGS. 23A and 23B present comparative x-ray spectroscopy (EDX) spectra showing respectively the elemental composition of the white and grey marked sections of the material using a 3 W ultraviolet laser.

FIGS. 24A and 24B present examples of either a prototype system or a commercial system designed, adapted, and configured to permanently mark select polymer materials.

FIG. 25 presents a flow diagram schematically illustrating an exemplary method of permanently marking a polymeric material.

FIG. 26 depicts a side operational view of a laser-marking system of the present subject matter adapted and configured for marking such items as lids, pouches, and trays.

Throughout the FIGS., and the detailed description which follows, similar reference numerals shall be used to refer to similar components of the present subject matter.

While many details, examples, and embodiments of the present subject matter are described in the following detailed description, and shown in the accompanying FIGS, it is to be understood that the present subject matter is not limited to the embodiments disclosed, and that the present subject matter can be modified for numerous applications.

Systems and methods of the present disclosure may be used to place a permanent mark on a material and may comprise elements disclosed herein. Such disclosure of possible constituent elements is intended to be exemplary only. It is not the intent of this disclosure to limit the systems or methods of the present subject matter to such elements. A person of ordinary skill in the art (“POSITA”) of the present disclosure may understand there to be equivalent elements that may be substituted within the present disclosure without changing essential functions or operations of the subject matter disclosed herein.

The various elements of the systems and methods of the present disclosure may be related. It is not intended to limit the scope or nature of the relationships between the various elements; and the following examples are presented as illustrative examples only.

### DETAILED DESCRIPTION

The marking of text and other graphical characters on polymer materials such as polyolefin-based materials, including thin and extruded films, can be performed utilizing inks that adhere to the polymer surface, after any desired pretreatment to lower the surface tension on the marked substrate. This system can be performed utilizing a flexographic printing system that uses fixed information printing plates and a secondary printing system to mark any desired variable information. The printing or marking of small and high definition characters (including 1D and 2D barcode elements) utilizing this method on spunbonded polyolefins (including, but not limited to, such commercial products as DUPONT® TYVEK® 2FS® 1073B and/or 1059B polymeric materials) are even more difficult with the printing inks due to the uneven surface texture characteristic of the filament elements of these materials, as well as the tendency of the water-based and the solvent-based inks, both migrating away from the marked character edges from capillary attraction prior to the drying of respective inks. This condition allows for marked 1D and 2D barcode elements to not maintain their originally designed shapes and sizes.

Laser marking systems vary in both their wavelengths, their output power, and their output streams (pulsed or continuous beams). For marking on polymers, and to obtain a visible contrast mark, some laser wavelengths do not perform well or have inherent safety issues when used. For example, wavelengths in the ultraviolet C (UVC) and ultraviolet B (UVB) range (100-300 nm) can be utilized to slowly mark: very small targets, e.g., on electronic components, but can be carcinogenic if not shielded properly.

Excimer laser light wavelengths of, for example, up to 351 nm are in a “cold class” of lasers and can be generally produced with low power outputs (about 5 mW to about 300 mW) for surgical applications, but generally don't perform well when used to mark polymers. A pulsed ultraviolet (UV) laser of wavelength of 355 nm and power output of about 1 W to about 3 W, while also in the “cold class” of lasers, can generate a low amount of heat that can be used to mark polymers. This allows a substrate to be marked without damaging its structure. Lasers in this class can be fitted with optics to provide a relatively small marking field. However, such lasers can be used to generate only one barcode and only two relatively short lines of text (for example, for a “lot coding” system). Green lasers (532 nm wavelength) can be produced with either pulsed or continuous operation and with about 1 W to about 50 W power output. Such lasers could also mark polymeric materials but may also char, melt, and/or warp-marked thin-film structures of the polymeric material.

Fiber and CO₂ lasers (in the 830 to 1024 nm wavelengths) with power outputs of from about 1 W to about 500 W, are identified as “hot” lasers and can be generally constructed to perform routine drilling, cutting, and/or engraving operations on assorted materials (e.g., operations for thick, molded parts with thicknesses ranging from 0.025 inch to 0.060 inch or higher and/or where damage is not an issue at temperatures exceeding 160° C.).

When using the systems of the present subject matter, an accurate and preselected high-definition marking of black and other colored text and graphics on a substrate may be accomplished with a combination of TiO2, CaCO3, and thermochromic coatings applied to Tyvek® materials including but not limited to 2FS, 1059B, and 1073B, and then activated using the laser system of the present subject matter. The laser system of the present subject matter may be used to place predetermined markings on coatings that have been applied to the external surfaces of such substrates as paper, Tyvek® material, and films, and within internal surfaces of select laminated films. Thermochromic materials, applied via select flexographic printing systems for external substrate coatings, may then be combined with select film-lamination adhesives, to produce multi-layer films.

The laser systems of the present subject matter could accomplish marking on surface coated materials by heating portions of the surface coatings to a predetermined activation temperature. Once activated by the laser energy of a laser beam of a system, the thermochromic pigment elements change color permanently and do not return to their original white coloration, without damaging the underlying substrate. For film laminations, the laser beam activates the thermochromic pigments in the same manner as for the surface coating applications. However, since the pigments are internal to and within the body of the film lamination, the outer layer of the lamination (PET, PP, HDPE, PA, etc.), which contains no pigmentation, remains unaffected by laser energy passing through it.

By way of non-limiting example, embodiments described in detail herein include methods of permanently marking a polymer material containing an opacification material, such as a polymer structure containing a pigment, titanium dioxide (TiO₂) and/or calcium carbonate (CaCO₃). Examples of polymeric materials that can be marked by UV laser include DUPONT™ TYVEK® brand materials (e.g., DUPONT™ TYVEK® 2FS™ material), spun-bonded polyolefin (e.g., high-density polyethylene with titanium dioxide additive), and hydro entanglement-generated polyolefin (polypropylene) fibrous sheeting, and solid polymer sheeting materials, including but not limited to polycarbonate, polyethylene terephthalate, acrylonitrile butadiene styrene, polyvinyl chloride (“PVC”), and other polymers that have an affinity of absorption of about 355 nm wavelength light.

The method may comprise marking the polymeric material with a laser system. The laser system can comprise a 355 nm±0.1 nm ultraviolet (UV) output power system. In other applications, for example with other materials, certain other laser systems May be used including but not limited to 355 nm±0.5 nm; 355 nm±1 nm; 355 nm±2 nm; 355 nm±3 nm; 355 nm±4 nm; or 355 nm±5 nm systems. Some UV lasers can be used with low output power (e.g., from 1 W to about 3 W) to not damage the material. In addition, such lasers could be used at a slow rate to provide a desired marking quality (e.g., clarity, contrast, etc.). Using low output power and slow rates may limit the amount and size of the markings. Methods described herein are capable of permanently marking a large quantity of marks on a large field size of a polymeric material without limiting the output power of the laser, at a faster rate, and without compromising the integrity of the material.

Examples provided herein can utilize a laser system that can include a solid-state nanometer wavelength diode pumped-and-pulsed unit. In certain instances, the laser system could include a variable-wattage solid-state diode pumped-and-pulsed unit. The average output power can be any wattage ranging from 1 W to 55 W or any range therein. In various implementations, average output power can be from 4 W to 55 W, 4 W to 50 W, 4 W to 40 W, 4 W to 30 W, 4 W to 20 W, 5 W to 30 W, 5 W to 20 W, 6 W to 20 W, 7 W to 20 W, 8 W to 20 W, etc. By using an output power of at least 4 W, the laser can be used at a faster (than normal) speed and have a desirable marking quality. In certain instances, the laser system can include a beam expander, such as a 2×, a 3×, a 4×, or a 5× beam expander. For example, a laser system can include a series of lenses such that the laser beam can be directed through the lenses to increase or decrease the diameter of the laser beam. The laser beam exiting the laser source can be expanded by multiples (e.g., 2×, 3×, etc.) of its original diameter depending at least in part on the intended application. In various implementations, a 2× beam expander could be particularly desirable because it May optimize a “dot” or “spot size” at the work surface. Larger expanders may reduce the dot or spot size at the work surface and reduce the line width and readability of the marking.

In certain cases, the laser system can include a dual-head “Galvo” (galvanometer) scan head. For example, a laser system could include two servo motor-driven mirrors (e.g., galvos) that deflect a laser beam in two different linear directions (e.g., an X-Y servo galvanometer scanner with beam deflector) to allow a beam to form a marked character. The laser system can be used at a minimum scan speed. For example, the laser beam can be directed or redirected by the scan head at a minimum speed ranging from about 1 meter per second to about 20 meters per second, or any range therebetween. In various implementations, a minimum scan speed of about 3 meters per second can allow faster marking and can help reduce and/or avoid damaging the material at higher output power. In some instances, the minimum scan speed can range from about 3 meters per second to about 8 meters per second, about 4 meters per second to about 8 meters per second, about 5 meters per second to about 8 meters per second, or about 6 meters per second to about 8 meters per second. In some cases, too high a rate may reduce the energy per pulse and reduce an ability to generate marking contrast. The laser system could Iso include a pulse frequency. For example, a pulse frequency could be at least about 30 KHz (i.e., about 30,000 pulses per second). In some cases, a laser system can have a variable laser frequency from, e.g., 1 to 150 KHz, or any range between, including 30 to 40 KHz and/or 30 to 50 KHz. In various implementations, a pulse frequency of at least 30 KHz can help reduce amount of imparted heat that may damage material than if a slower pulse frequency were used. In some instances, too high a frequency may slow down an ability to mark, since laser pulse energy can diminish when frequency is increased. The laser system in some implementations can use a focusing lens system (e.g., an F-Theta 810 objective focusing lens) to create marking field sizes of from approx. 100 mm×100 mm to 500 mm×500 mm, resulting in a spot size of from 120 to 100 microns with a pulse energy of 160-400 micro joules per pulse. In some instances, during the marking step, and to control the marked field size, the laser may be positioned a distance of approx. 200-990 mm from the substrate to be marked. The marking speed can depend at least in part on the laser pulse frequency, scan head capacity, field size, font type, lens focal length, and/or character size. The font type can be a vector or raster type font. In some implementations, vector type fonts can mark faster than raster type fonts for the same number and size of characters to be marked. The overall character size can range from 0.25-point type to a total, focused field size of a laser system. In various implementations, a character size can range from 8-point to 16-point type that is readable by a human eye. For example, the character size can range from 10-to 14-point type or 10-to 12-point type. In some cases, from 500 to 2500 characters, or any range therein (e.g., 500 to 1000, 500 to 1500, or 500 to 2000 characters), with a font size of 8-to 16-point can be marked within 5 seconds, 4 seconds, 3 seconds, 2 seconds, or sometimes 1 second or less. In some cases, one marking cycle can mark up to 2000 characters with a font size of 10- to 12-point type within 5 seconds. Some implementations can mark 1 to 25 cycles in a minute (or any range therein e.g., 1 to 15, 1 to 12, 1 to 10, 5 to 15, 5 to 12, 5 to 10, etc.) as may be desired by a packaging machine's line speed. Various examples are possible.

Depending at least in part on the pulse frequency, scan speed, and/or focal lengths of lenses, the marking color may be varied from a light grey to a charcoal coloration. In some implementations, if the pulse frequency and/or scan speed is too slow, then the imparted potential energy may begin to cause damage to the material by overheating the base-layer polymeric material, to cause melting and/or cratering at a laser beam contact point, and even possibly transform portions of polymer into carbon. Carbonized polymer may appear dark grey or black in color. While some cratering (a maximum depth being, e.g., about 10 microns, 7 microns, 5 microns, 3 microns, or 1 micron) could be acceptable for certain materials and may not physically deteriorate such material, certain other cratering, that is too great may negatively impact integrity of the material. Therefore, for certain cases, if a pulse frequency or scan speed is too high, a marking speed or mark contrast could be diminished. In various instances, the pulse frequency can be balanced against preselected scan speed and output power for desired marking rate and contrast.

In various implementations, the material can be marked with multiple characters (e.g., 500⁺ characters such as from 500 to 2500 or ranges therein, in a font size ranging from about 8- to 16-point font) and a barcode (e.g., 2D barcode) and human-readable identification characters. An ISO (International Organization for Standardization) symbol grade could be used to describe the marking quality of a symbol. In some instances, a 2D Data Matrix barcode could denote a marking quality using an ISO/IEC 15415:2011 symbol grade of at least 2.0, 3.0, or 4.0 for an aperture (mils), light source (nm), and angle (or an equivalent February 2011 ANSI grade of at least C, B, or A) pursuant to 2015 2D Barcode Verification Process Implementation Guideline per GS 1 Data Matrix Guideline Release 2.5.1, Ratified, January 2018. The grades range from 0.0 to 4.0 with 4.0 being the highest or “A” to “B” to “C” to “D” to “F” with “A” being the highest. As an example, marking quality can be given as the grade/aperture/light/angle (e.g., 3.0/10/660 with the angle assumed to be 45° if not provided). The symbol grade can be the lowest grade out of each individual criterion. In some instances, a barcode can meet ISO/IEC 15415:2011 standards for one, all, or any combination of the individual criteria of decode, symbol contrast, axis nonuniformity, modulation, grid nonuniformity, unused error correction, fixed pattern damage, and print growth. For the criteria of symbol contrast, a result of 30 to 60 4% contrast can yield a 4.0 or an “A” grade. Alternatively (or additionally), a barcode can meet the May 19, 2015, American Standard AS 9132. In some cases, a barcode can meet the May 19, 2015, American Standard AS 9132 standards for one, all, or any combination of individual criteria of angle of distortion, filled cells, center point discrepancy, elongation, number of dots per element, and quiet zone. Alternatively (or additionally), a barcode can meet ISO/IEC TR 29158:2020 Direct Part Mark Quality Guideline. In some instances, the barcode can meet ISO/IEC TR 29158:2020 standards for one, all, or any combination of the individual criterion of decode, symbol contrast, axis nonuniformity, modulation, grid nonuniformity, unused error correction, fixed pattern damage, and print growth. Alternatively (or additionally), the barcode can meet ISO/IEC TR 29158:2020 standards for the individual criteria of modulation within a cell and/or with a minimum reflectance.

### Example 1

Using Raman spectroscopy testing methods, laser marking on a TYVEK® 2FS™ material sample was tested to determine chemistry of a laser mark upon a high-density polyethylene (HDPE) sheet, wherein the laser mark was created using an 8-watt UV laser.

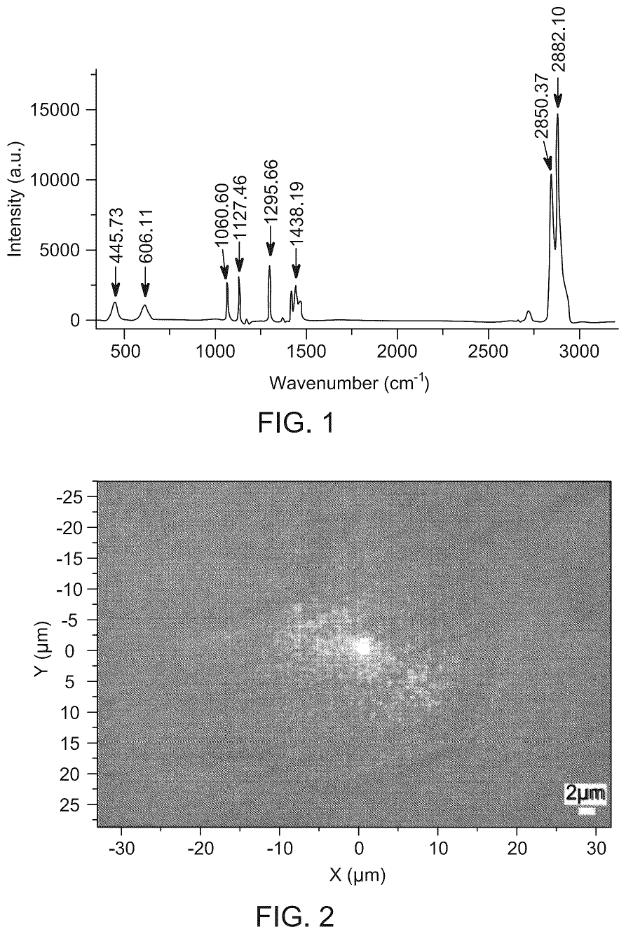

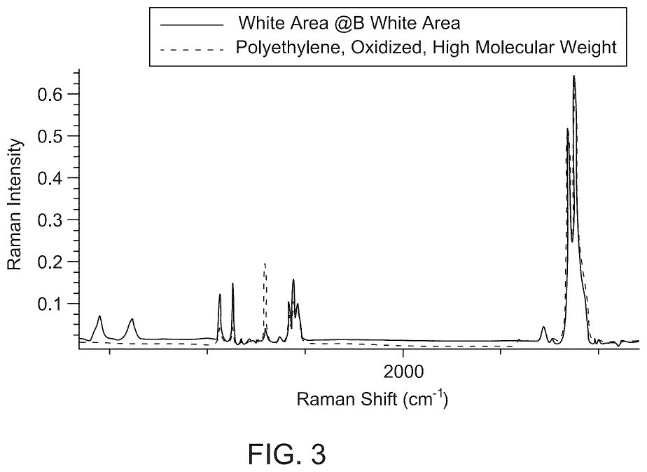

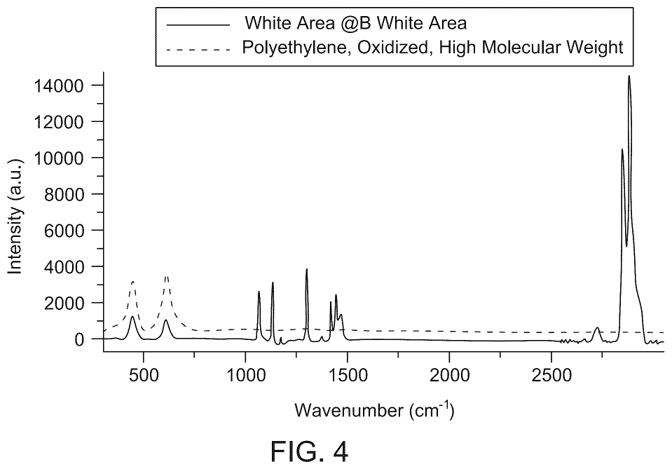

First, a white (e.g., unmarked) area of a sheet of material was measured using a LabRam HR Evolution (brand) spectrometer. 352 nm wavelength was used as excitation for Raman spectra, collected in backscattering geometry) (180° using an Olympus microscope. FIG. 1 was obtained from the white area of the sheet presented in FIG. 2. FIG. 1, a typical spectrum of HDPE, is presented in overlaid spectra shown in FIG. 3. The additional bands shown at 450 and 606 cm⁻¹ (presented in FIG. 3) are two bands of TiO₂ in rutile form (also shown in FIG. 4) are used to give the TYVEK® material its white color.

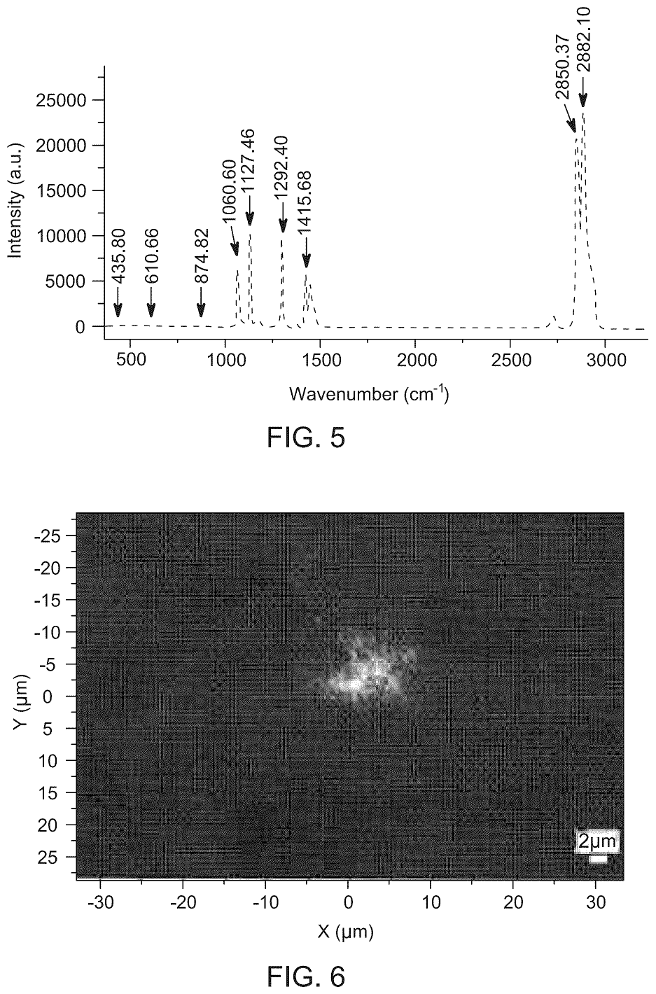

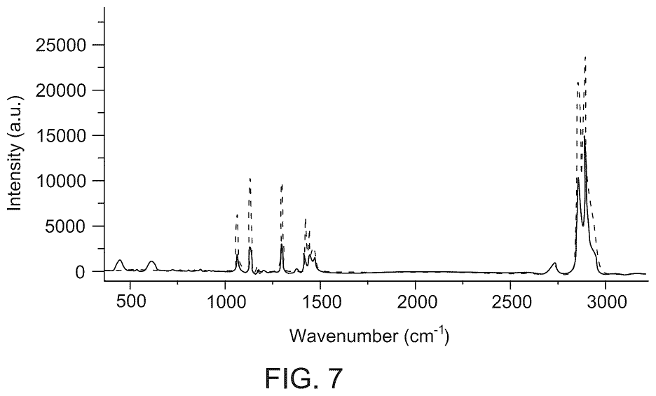

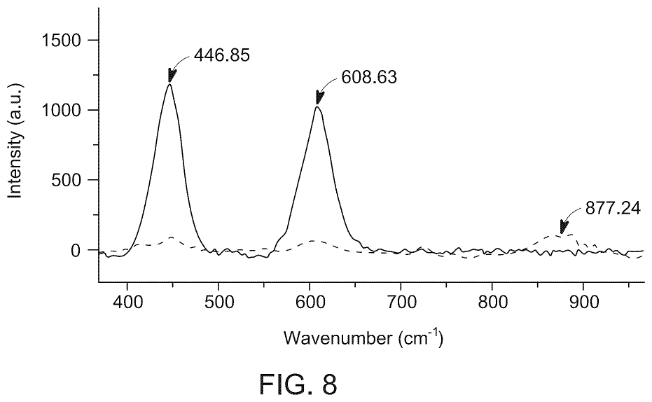

Then, a grey area produced by the laser (see FIG. 6) was measured using the same procedure. FIG. 5 was acquired from the grey area. As shown in FIG. 7 and shown even better in the enlarged (I.e., “zoomed in”) view presented in FIG. 8, the TiO₂ bands (at 450 and at 606 cm⁻¹) are depleted and barely detected, while a very weak broad band was detected at a higher wave number (877 cm⁻¹), which could be speculated to be due to a TiO₃ ion. Thus, it appears that TiO₂ is depleted under the laser action, after which it is transformed into other titanium-based species, such as Ti metal and titanate(s). The grey color further suggests that Ti metal is also possibly present in the laser-marked area.

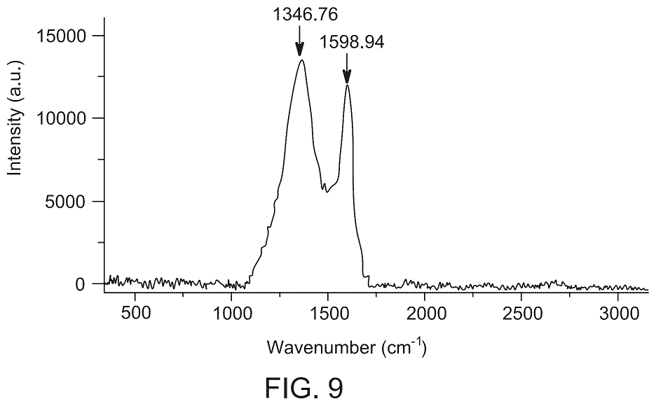

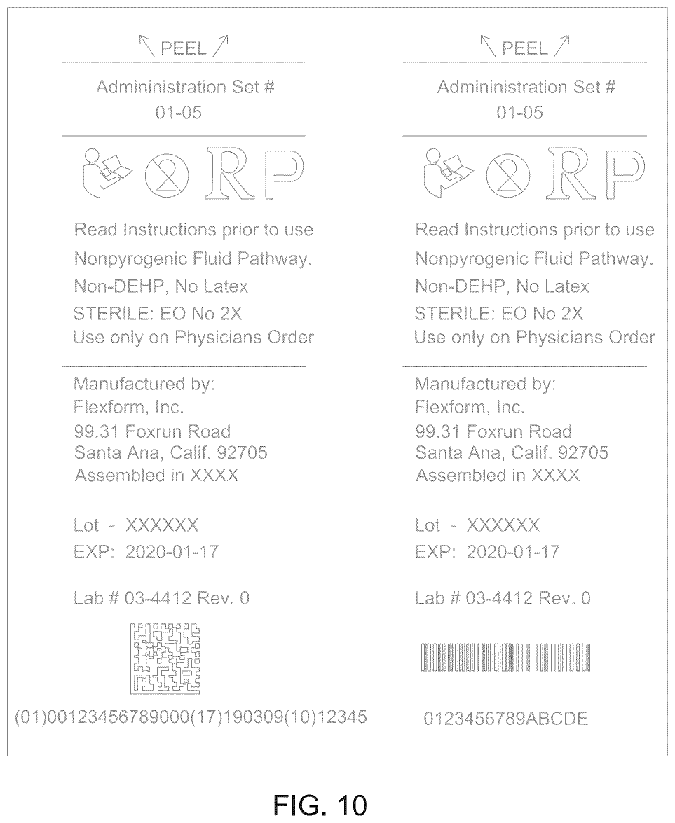

No decomposition of polymer into carbon was detected in laser marks, since no sp2-bonded carbon spectra (carbon black: see reference spectra, FIG. 9) were detected. FIG. 10 shows an example pair of package labels marked with an 8-watt UV laser in 1.4 seconds. The barcodes produced by the 8-watt laser satisfied the GS 1 standard (for example, such as GS1 Data Matrix Guideline Release 2.5.1, Ratified, January 2018) for barcodes in all testing requirements (for example, such as ISO/IEC 15415:2011, dated May 19, 2015, as American Standard AS 9132, ISO/IEC TR 29158:2020, and so forth).

### Example 2

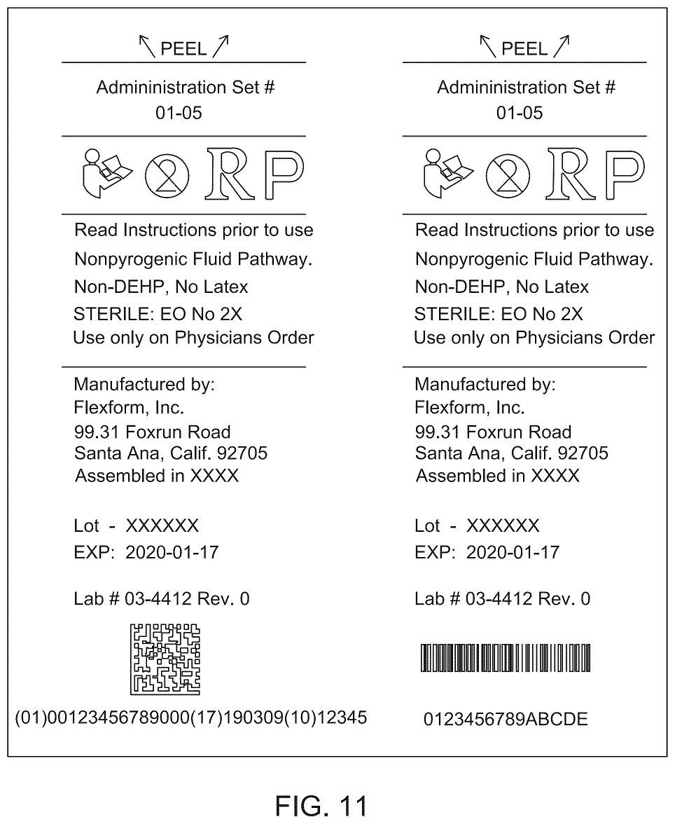

Laser marking on a TYVEK® 2FS™ material sample was tested. The laser mark was created using a 20-watt UV laser. The marks produced using the 20-watt laser appear to have very high contrast and do not appear to damage the TYVEK® 2FS™ material. Additionally, the 20-watt samples were able to be generated more quickly than the 8-watt samples from Example 1. As an example, FIG. 11 shows an example pair of package labels marked with a 20-watt UV laser in under 1.0 second. The barcodes produced by the 20-watt laser met the GSI standard (e.g., GSI Data Matrix Guideline Release 2.5.1, Ratified, January 2018) for barcodes in all testing requirements (for example, ISO/IEC 15415:2011 May 19, 2015 American Standard AS 9132, ISO/IEC TR 29158:2020, etc.).

### Example 3

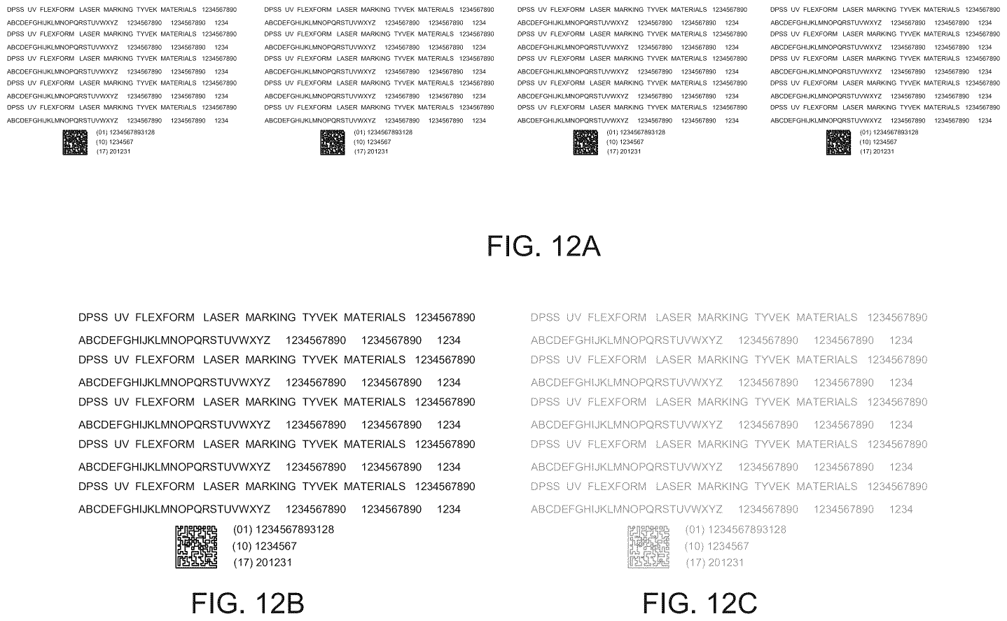

Another example of the present subject matter, FIG. 12A, shows an example of laser marking of a TYVEK® 2FS™ material sample using a 20-watt UV laser. A label 3 (measuring 3.5 inches×8.5 inches) included 500⁺ text characters in 10-point font size, a 10 mm×10 mm barcode, and human readable barcode content. During one cycle, 4 labels were made in 2.9 seconds. FIG. 12B depicts one of the 4 labels. The marks produced have very high contrast and clarity and have no cratering or melting of the TYVEK® material sample. Time to generate 4 labels was sufficient to maintain a packaging machine's line speed at 8-9 cycles per minute. Using an 8-watt IV laser, another 4 labels were made, this time in 3.6 seconds, which was also sufficient to maintain a packaging machine's line speed at about 8 to 9 cycles/minute. FIG. 12C shows one of these 4 labels.

Barcodes produced by the 8-watt and 20-watt lasers both satisfied met the GS1 standard (e.g., GS1 Data Matrix Guideline Release 2.5.1, Ratified, January 2018) for barcodes in all testing requirements (e.g., ISO/IEC 15415:2011 May 19, 2015, American Standard AS 9132, ISO/IEC TR 29158:2020, etc.). For the 4 barcodes produced by the 8-W laser, ISO grades were DPM4.0/07/660/D, DPM4.0/07/660/30Q, DPM3.0/07/660/D, and DPM4.0/07/660D. Each ISO symbol grade was reported as the lowest grade out of each individual criterion. A single grade of 3.0 was recorded for fixed pattern damage for one of the 4 labels with the remainder of the grades being 4.0. The cell contrast ranged from 38-45% (4.0 or “A” grade). For the 4 barcodes produced by the 20 W-laser, the overall ISO grades were DPM3.0/07/660/30Q, DPM3.0/07/660/30Q, DPM3.0/07/660/D, and DPM3.0/07/660/30Q. Four out of four polymer material tests in cell modulation were recorded as 3.0, two out of four tests in fixed pattern damage were recorded as 3.0, and one out of four tests in unused error correction was recorded as 3.5, with remaining grades recorded as 4.0. Cell contrast ranged from about 35% to 39% (4.0 or “A” grade).

### Example 4

Laser marking on a sample of TYVEK® polymeric material was tested. A laser mark was created using a 3-watt UV laser with a pulse frequency of 40 Hz. Samples were collected and adhered to SEM sample stubs (with double-sided carbon tape) for analysis.

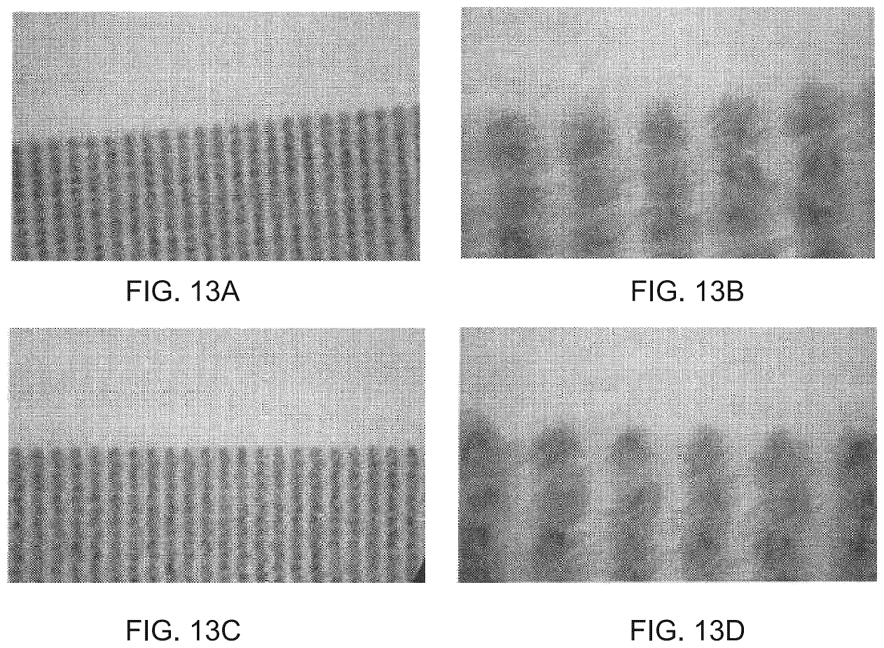

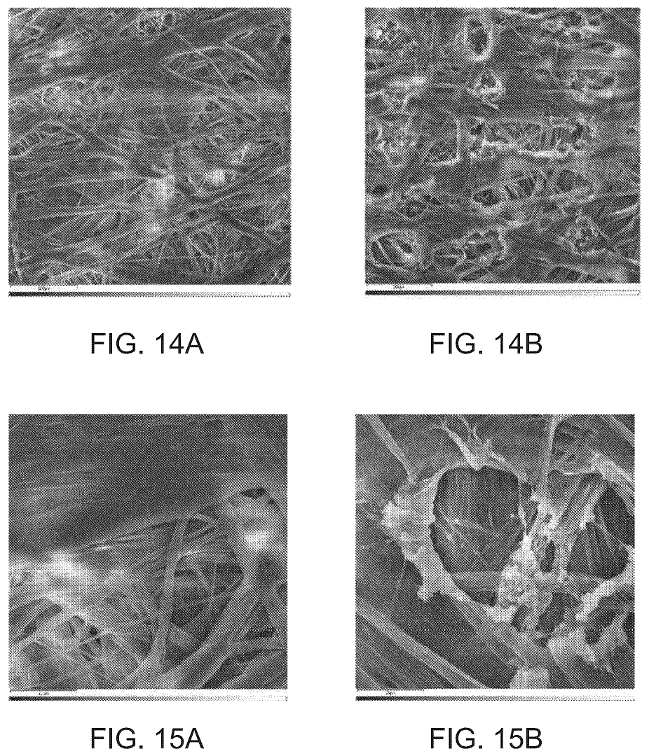

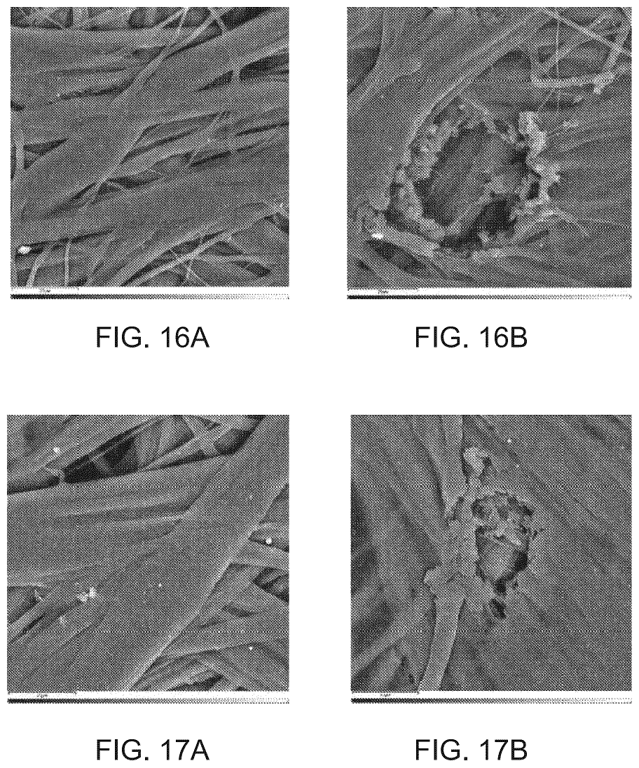

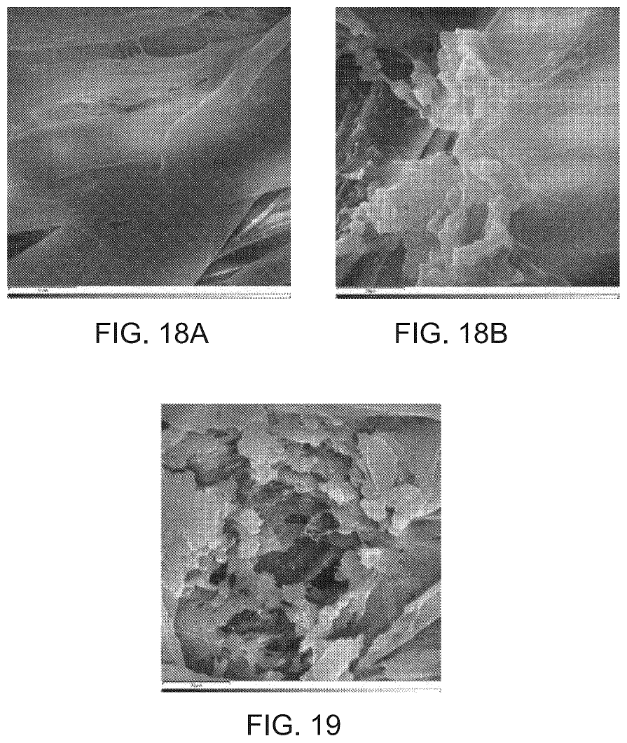

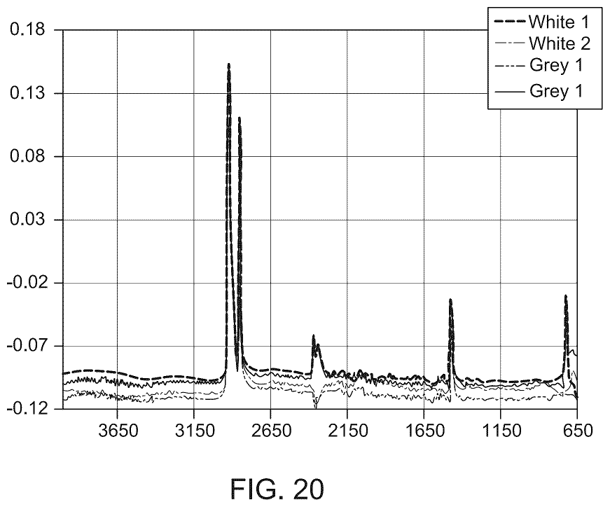

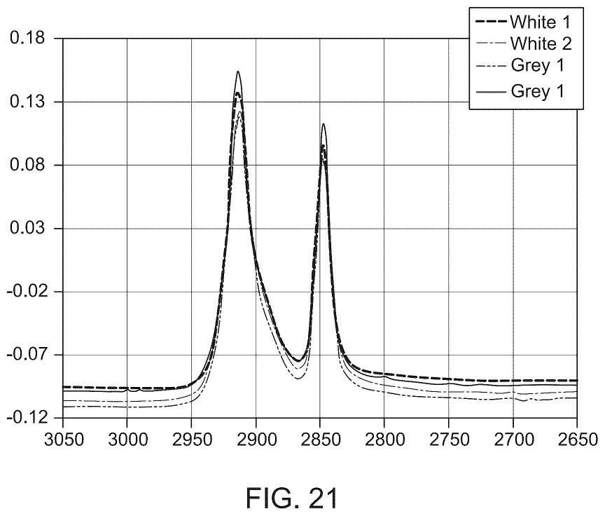

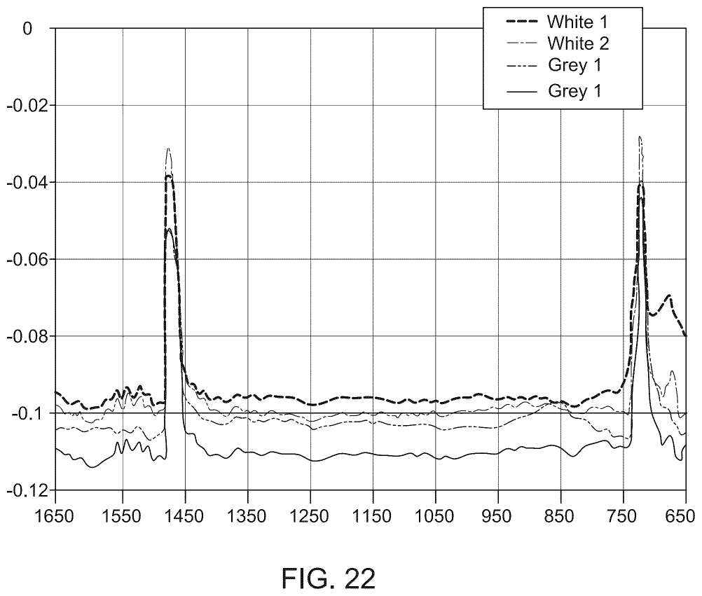

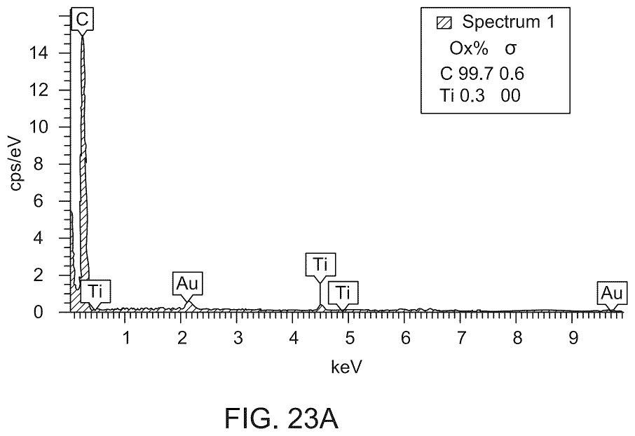

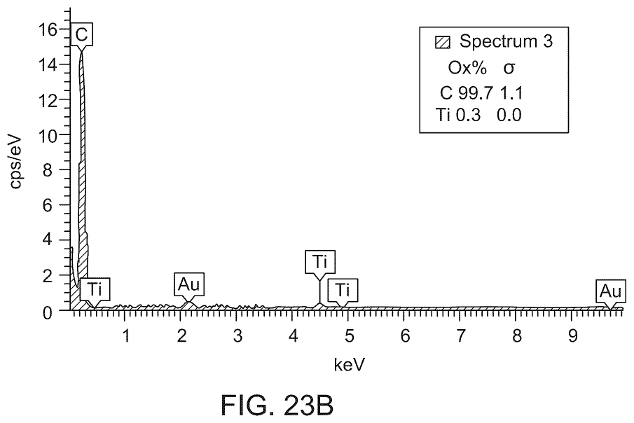

Analysis by scanning electron microscope (“SEM”) can indicate physical alteration of polyethylene-material sample within its grey-marked regions. No elemental changes were observed by energy-dispersive x-ray spectrometry (“EDX”). Analysis of the material by Fourier transform infrared (FTIR) spectroscopy did not clearly indicate a chemical change to the bonded polyethylene. FIGS. 13A-13D shows random laser marked (“RLM”) images of the two marked sections of the sample showing the change in coloration due to the laser marking process. A 500× image comparing the white and grey sections of the material is shown in FIGS. 14A and 14B respectively, while a 2000× image comparing the white and grey sections of the material is shown in FIGS. 15A and 15B, respectively. FIGS. 16A-16B and 17A-17B show 2000× (electron backscatter) images comparing the white (FIGS. 16A and 17 A) and grey (FIGS. 16B and 17B) sections of the polymeric material, wherein the white spots are titanium dioxide deposits. FIGS. 18A and 18B show 5000× images comparing respectively the white and grey sections of the material, and FIG. 19 shows a 5000×0 image of the grey section of the material with an area effected by the laser. The characteristics shown in FIG. 19 were not observed on the white material. FIGS. 20-22 show comparative FTIR spectroscopy spectra of two sections of the white material and two sections of the grey affected sections of the material. FIGS. 23A and 23B show comparative EDX spectra showing, respectively, the elemental composition of the white and grey marked sections of the material. Data is presented in Table 1 below:

TABLE 1

| Peak | White | |
|---|---|---|
| Region | Material | Grey Area |
| (cm⁻¹) | Peak Height | Peak Height |
| 2910 | 0.2026-0.2419 | 0.2342-0.2528 |
| 2845 | 0.1631-0.2000 | 0.1941-0.2107 |
| 1462 | 0.0580-0.0721 | 0.0604-0.0688 |
| 717 | 0.0589-0.0661 | 0.0681-0.0714 |

Data presented in Table 1 suggests that darkening observed is a result of thermal damage to the polymeric material, causing a loss of the hydrogen and oxygen atoms, and leaving carbon, which is known to cause alterations in the color of materials. Analysis of pore depth by SEM focal point depth analysis indicated that etched sections extend about 0.93 micrometers (“μm”) into the fabric (0.01 μm minimum and 6.6 μm maximum, depth).

While this example shows cratering less than the 10-micron maximum allowable, it also provides evidence of carbonization as well as the melting and/or cratering of the polymeric material due to utilization of the 3-watt laser system disclosed in detail herein.

### Example 5

A comparison between a low-power and smaller-field-sized laser can be demonstrated by the following example. Markings were generated by using a 2-watt UV laser including a 3× beam expander and a dual head Galvo scan head. The laser was used at a scan speed of 3 meters/second, and a variable laser pulse frequency at 30 KHz. A single label, as shown in either FIG. 12B or FIG. 12C (but not replicated 4 times) was generated in 12.38 seconds. A barcode alone (without its 500 characters) was produced in 0.972 seconds. The barcode yielded an overall symbol grade of DPM2.0/11/660/D. The fixed pattern damage had a “C” grade, which is the lowest acceptable grade. The cell contrast was at 29% (“B” grade). The contrast in the label could not compare to the higher power 8-watt and 20-watt lasers used in Example 3. To achieve a similar contrast, the marking speed decreased even further and damage to the substrate was demonstrated.

TABLE 2
Irreversible Color-Changing Coating Materials:

| Item | | |
|---|---|---|
| No. | Video Title | What Video Depicts |
| 1 | Video_2 INX-Version A (Jun. 1, 2023) | See Comments (below) |
| 2 | Video-50-lb paper and Green | See Comments (below) |
| | thermo ink (Sep. 9, 2022) | |
| 3 | Video_1073B and Blue thermo ink | See Comments (below) |
| | (Sep. 9, 2022) | |
| 4 | Video_1073B and thermo black ink | See Comments (below) |
| | (Sep. 9, 2022) | |
| 5 | Video_1073B and UVC bi-color ink | See Comments (below) |
| | (Sep. 9, 2022) | |
| 6 | Arthrex LOGO (Jul. 3, 2024) | See Comments (below) |
| 7 | 500 character marking with speed | See Comments (below) |
| | squares (0.5 seconds) (Mar. 15, 2021) | |
| 8 | Video_2 | See Comments (below) |
| 9 | Backer card marking with UV laser-1 | See Comments (below) |
| 10 | CNG-4 mil., 1 layer CaCO3, 2.1 W | See Comments (below) |
| | laser, 3000 mmsec. (Mar. 23, 2023) | |
| 11 | CNG-4 mil., 2 layer TiO2, 20 W laser, | See Comments (below) |
| | 3000 mmsec. (Mar. 23, 2023) | |

### Example 6

Videos noted include INX coating (Ver. A) on 1059B Tyvek (White to grey) also referred to as Video 2 (6-1-23), item No. 1; included are Spotsee coatings on 1059B Tyvek for Green on 50-lb, heat seal-coated paper (9-9-22) (Ringermann=3.0), item No. 2; and item Nos. 3-5, Blue (dark) on 1073B Tyvek> (9-9-22) (Ringermann=4.0); Black on 1073B Tyvek® (9-9-22) (Ringermann=4.0); and Bicolor (blue to red) on 1073B Tyvek® (9-9-22) (Ringermann=3-4). A first pass with a laser beam turns the materials from white to blue and a second pass with the laser beam turns the blue marking to a red mark. Irreversible laser markings were done without damaging coatings or substrate materials.

Also disclosed herein and summarized in Table 2 above are additives to the substrate materials, added within layers of materials of multilayer substrates adapted and configured to be permanently marked with the laser system of the present subject matter. These include a white logo (Arthrex) on a black HDPE substrate. An additive to substrate is carbon black. A black marking on a white HDPE substrate. An additive to the substrate is TiO2 (about 5-7 wt.-%). A gray marking on a brown multi-layer substrate (PET/PE/PE); the middle layer has no marking on its outer layers; middle layer contains TiO2 and brown colorant (Ringermann=2-3); a backer card with text and graphics (HDPE material with TiO2 additive) (Ringermann=4-5); an HDPE film (4 mil.) with CaCO3 additive (Ringermann=4); and HDPE film (4 mil., 2 layer) with TiO2 additive (Ringermann=4).

Note 1. Additional materials (substrates) to be marked with the laser systems of the present subject matter include but are not limited to the following: 1059B and 1073B Tyvek® branded substrates with ink coatings that include TiO2, CaCO3, Leuco dyes (encapsulated); Pigments, dyes, BPA, and formaldehyde; Paper materials 38-lb. through 92-lb paper stock with ink coatings that include TiO2, CaCO3, Leuco dyes (encapsulated); Pigments, dyes, BPA, and formaldehyde; Polymer films; including single and multilayer co-extrusions and laminations with additives that may include TiO2, CaCO3; Pigments, dyes, BPA, and formaldehyde; Polymer film resins that may include but not be limited to: HDPE, PP, PLA, PET, PA, TPE; TPU, Styrene, ABS, PVC, and select other resins, with preselected additives reactive to identified UV laser wavelength (TiO2 and/or CaCO3).

Note 2. Identification of substrate coatings and coating application types to be marked with laser systems of the present subject matter may include but are not limited to: flexographic ink (for Tyvek® branded and common paper substrates); ink components disclosed herein; flexographic printing (for Tyvek® branded and paper substrates); solvent-based lamination-process adhesives for polymer, paper composites, and foil-based composites; and water-and solvent-based coatings with additives. Coating bases may include but are not limited to acrylic resins (about 20-80 weight-percent); MEK (about 30-60 wt.-%); alcohols (about 20-40 wt.-%); varnish (about 20-80 wt.-%); and water (about 30-60 wt.-%). Additives may include but are not limited to: titanium dioxide (about 0.5-7 wt.-%), calcium carbonate (about 0.5-7 wt.-%), clays (about 0.5-7 wt.-%), carbon black (about 1-8 wt.-%), Leuco dyes (encapsulated) (about 1-10 wt.-%), pigments (about 1-10 wt.-%), bisphenol A (about 1-10 wt.-%), and formaldehyde (about 0.0 to 0.5 wt.-%).

Note 3. Commercial suppliers of pre-formulated inks, coating materials, films (including but not limited to mono-layer and co-extrusion films), substrate coatings, and coating application types adapted to be marked with laser systems of the present subject matter include but are not limited to: INX International, a Flexographic ink coating supplier; Roland Associates, a Flexographic ink-coating supplier; Foshan Yinya Technology Co., LTD (China), a water- and solvent-based Flexographic ink supplier; Xiamen Magic Color Technology Co., LTD (China), a water- and solvent-based Flexographic ink supplier; Brandt Technology, a TiO2 and CaCO3 supplier; Technipaq Inc., a Tyvek® branded and paper coating producer of examples for this disclosure, including film lamination material converting examples, and suppliers including but not limited to Charter Next Generation Films, Inc., a polymer film extruded and/or film lamination material-converted supplier.

Note 4. Disclosed herein are coating materials with additives manufactured to demonstrate an irreversible color change from an initial first color to a contrasting second color (for example, white to black, white to blue, white to green, white to red, and so forth) when irradiated with UV laser energy (352 nm-355 nm wavelength). Also disclosed herein are coating base materials with additives that demonstrate an irreversible color change to a contrasting color (white to black, white to blue, white to green, white to red, and so forth) when irradiated with UV (ultraviolet) laser energy (352 nm-355 nm wavelength) and which achieve a temperature of about 120 degrees Centigrade to about 150° C., without damaging or degrading the underlying coating base material and/or coated substrate.

Note 5: The identified coatings are laid down using a flexographic printing process of the present subject matter, with coating thicknesses ranging from between about 4 to about 10 BCM (Billionth of a cubic meter). They are also high-temperature formulations formulated to avoid charring and/or ablation of material during the marking process. The observed results indicate that TiO2 and CaCO3 additives in the coatings will permanently change from white to black or gray when irradiated with the UV laser system, and that the marking process will not damage the underlying Tyvek (brand) material or film substrates.

Example 7

This listing is the only information that personnel at the Chinese company, Foshan, are willing to divulge. It is the same for all four ink colors (Black, Blue, Green, and Red). Therefore, I am presuming that all are the same, except for the pigments. They are listing their inks as water-based, but they recently divulged that the inks are not water-based, but rather, are “water-soluble” (and may be either oil-in-water or water-in-oil emulsions.)

TABLE 2
Thermochromic Water-Based Ink

| | Weight |
|---|---|
| | Percent |
| Main Ingredients | |
| Butanone (MEK) | 30-60 |
| Ethanol | 30-60 |
| 1-methoxy, 2-propanol | 10-30 |
| Methanol | 1-5 |
| Pigment(s) | 1-5 |
| Other Ingredients | |
| 4,4-Isopropylidenediphen | 1-10 |
| Formaldehyde | 0-0.5 |

Pigments in the inks listed in Table 2 are from Roland Associates. The Roland Associates inks and black ink from Foshan were tested at a laser lab. This includes the blue-, green-, and red-ink formulations from Foshan. Also tested were ink formulation formulations from another company (Spotsee) tested about two years before this disclosure was filed, using a heavier silk screening coating weight. All these tested well.

### Exemplary Marking Systems

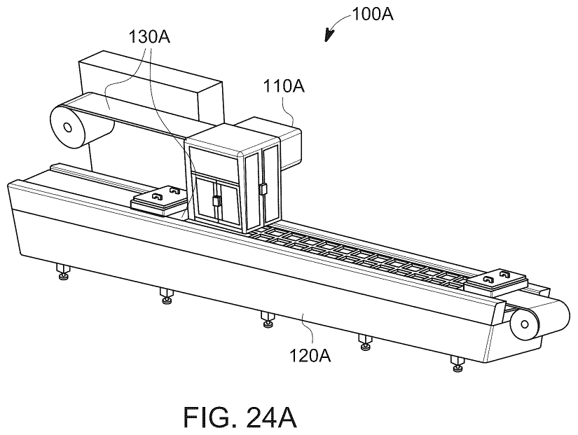

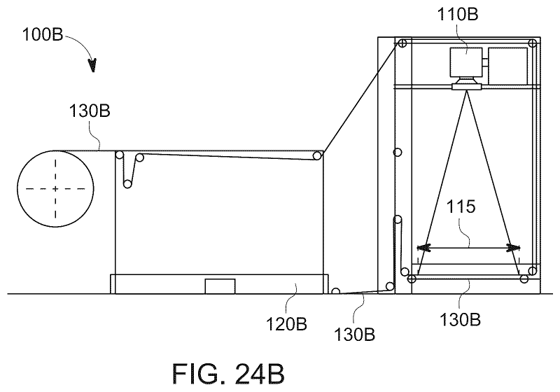

FIG. 24A depicts an exemplary system 100A designed, adapted, and configured to permanently mark a polymeric material. Marking material system 100A includes a laser system 110A and an associated packaging machine 120A. Laser system 110A is shown mounted to a loading bed of the packaging machine 120A. FIG. 24B depicts another exemplary system 100B with a laser system 110B associated with a packaging machine 120B. In both FIG. 24A and 24B, the path of the polymeric substrate material 130A, 130B can be seen from a roll of material, into a marking field 115 (FIG. 24B) of the laser system 110B and out of the marking field 115 of laser system 110B. For example, the packaging machine 120A, 120B can be configured to hold (intermittently in some instances) a portion of such material 130A, 130B within the marking field 115 of the laser system 110B for a predetermined amount of time (e.g., 4-60 seconds). Upon receiving a signal from the packaging machine 120A and 120B, its laser system 110A and 110B can be configured to mark a portion of the material 130A and 130B within the marking field 115 of its laser system 110A, 110B in the predetermined amount of time. The laser systems 110A, 110B could include any conventional laser system, including any laser system described in detail herein. Upon receiving a signal from the laser system 110A or 110B, its packaging machine 120A, 120B could be configured to feed the marked portion out of the marking field 115 of its laser system 110A, 110B and thereafter feed a successive portion of the polymeric material 130A, 130B into the marking field 115 of its laser system 110A, 110B. Since various implementations of such laser systems 110A, 110B can be designed, adapted and configured to mark respective portions of the material 130A and 130B, the packaging machines 120A, 120B can be configured to feed respective marked portions of the material 130A, 130B from the marking field 115 of its laser system for a designated number of cycles (e.g., 1-25 cycles/minute or any ranges therein including but not limited to 1-15 cycles, 1-12 cycles, 1-10 cycles, 5-15 cycles, 5-12 cycles, 5-10 cycles, and such).

Moreover, each laser system 110A, 110B could be in a fixed, mounted position above, below, or to the side of polymeric substrate material 130A, to be marked. Material 130A, may be a continuous web of material received by each laser system 110A and 110B, in stopped configuration until marking is to be performed. Labeling artwork may be generated by an equipment owner, via label generating software (e.g., Adobe Illustrator, Corel Draw, etc.) in, for example, a .dxf-type file format, and can be stored in a mainframe network computer, a PC, or a laptop computer. The laser system can use a control system to process input data and control each laser system and associated galvanometers. An artwork file could be downloaded to the laser controller or to a corporate network connected to a PC computer or the laser controller. When such laser systems 110A, 110B receive a downloaded computer file, it can wait for the packaging machine 120 to provide a “start” signal. Once received, each laser system 110A, 110B can execute artwork marking onto the material 130A, 130B. Once this step is completed, each laser system 110A, 110B can signal its associated packaging machine 120A, 120B to continue with its predetermined artwork-and-information printing operations. Such signal exchanges can be repeated between the laser systems and the packaging machines until the designated number of machine cycles have been accomplished. Many other examples are possible.

In certain implementations, each system 100A and 100B may further include a temperature control system, e.g., to control the temperature of each laser system. In some cases, the temperature control system can include a liquid-coolant chilling system.

### Exemplary Method

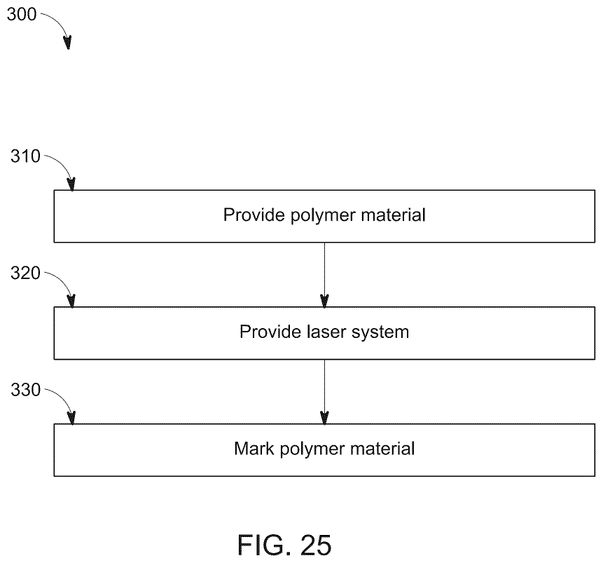

FIG. 25 presents a flow diagram schematically illustrating an exemplary method 300 of permanently marking a material. Method 300 can include providing a polymeric substrate material as shown in block 310. Such material can include, but is not limited to polymers described herein, such as polymeric material containing opacification material. As examples, suitable polymeric substrate material can include spun-bound polyolefin or hydro-entanglement-generated polyolefin fibrous sheeting. For example, such polymer material can include high-density polyethylene such as DUPONT™ TYVEK® brand materials (e.g., DUPONT™ TYVEK® 2FS™ material). In certain cases, such polymeric material can include solid polymer sheeting. In some cases, the polymers can include polycarbonate, polyethylene terephthalate, acrylonitrile-butadiene-styrene, or polyvinyl chloride (PVC). In some instances, the opacification material can include titanium dioxide.

Method 300 can include providing a laser system as shown in block 320. The laser systems 110A, 100B could each include an ultraviolet laser. For example, Such UV laser could comprise a 355 nm±0.1 nm UV laser. In certain other applications, e.g., with select materials, other UV lasers can be used but are not limited to 355 nm±0.5 nm, or 355 nm±1 nm, or 355 nm±2 nm, or 355 nm±3 nm, or 355 nm±4 nm, or 355 nm±5 nm systems. Such lasers can include a diode pumped-and-pulsed solid-state laser. In some implementations, such lasers can have an average output power of 1-55 W. For example, the output power can range from 4 W to 55 W, or 4 W to 50 W, or 4 W to 40 W, or 4 W to 30 W, or 4 W to 20 W, or 5 W to 30 W, or 5 W to 20 W, or 6 W to 20 W, or 7 W to 20 W, or 8 W to 20 W.

As shown in block 330, method 300 can include marking the polymer material with such lasers. In certain cases, such lasers can mark the polymer material at a scan speed ranging from 1 meter per second to 20 meters per second. Scan speeds can range from 3 meters per second to 8 meters per second, or 4 meters per second to 8 meters per second, or 5 meters per second to 8 meters per second, or 6 meters per second to 8 meters per second and/or a minimum pulse frequency ranging from 1 KHz to 150 KHz. In operation, pulse frequencies can therefore range between 30 KHz to 40 KHz or between 30 KHz to 50 KHz. For certain methods, such lasers can produce less than 10microns, 7 microns, 5 microns, 3 microns, or 1 micron of cratering in the polymer material.

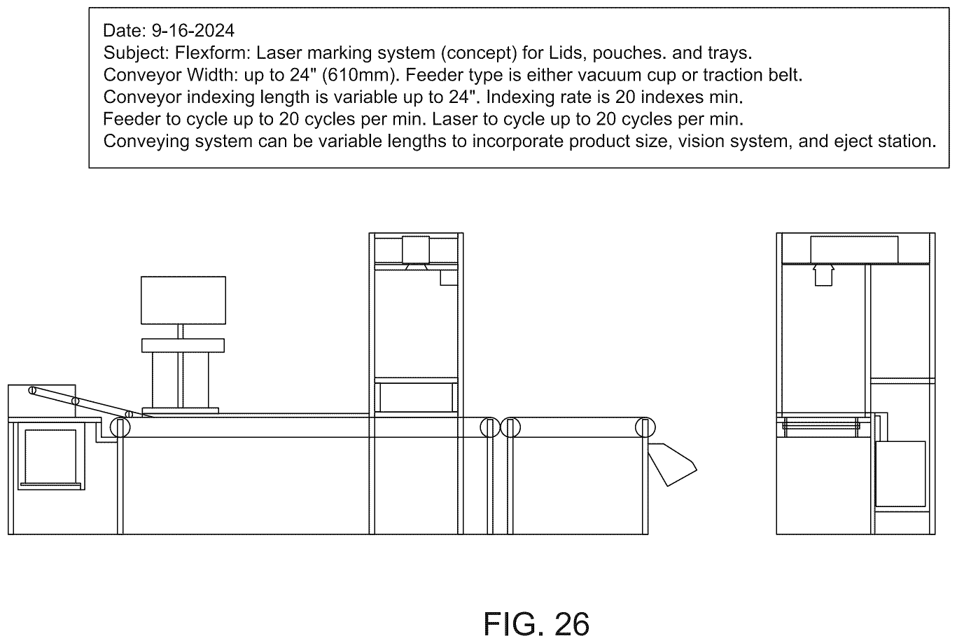

FIG. 26 presents a feeder and indexing components which, while commercially available, when integrated with a laser marking system and inspection components depicted, and operated in combination with the several components shown, presents an embodiment of a material-handling and-processing system of the present subject matter.

FIG. 26 depicts several mechanical components which, when combined, present an embodiment of the material processing system of the present subject matter. The feeder and indexing components do exist and are in commercial use, however when they are integrated with a laser marking system and the inspection components disclosed, the integrated system becomes a novel and unique processing system. Feeding systems depicted in FIG. 26 may include stand-alone systems adapted and configured to feed precut and flat sheeting materials. The indexing system and the conveying systems are also commercially available and can be used with or without a feeder. These types of feeding and conveying systems are often commercially used with single lane, continuous ink-printing systems for US mail and advertising operations. They only use ink-printing systems (inkjet and dry-ink contact thermal transfer) methods for marking. The inkjet systems have limitations in that an ink printhead must be within 1 mm of a substrate and printhead nozzles must not contact the substrate. Also, the thermal transfer systems also have a limitation in that the printhead and ribbon (ink) must contact the substrate for a transfer of a mark to be made. Both types of systems also require that the substrate, to be marked, be flat and have no undulations or contours to disrupt the printing or marking operations. Both systems require the use of a consumable marking material (including but not limited to ink, cleaning solutions, and transfer ribbon). Due to inkjet printing systems currently having relatively small diameter ink distribution nozzles, a clogged nozzle will not distribute a required amount of ink but will instead print either an incomplete or an incorrect barcode. The same result is also inherent with thermal transfer print heads when a pixel-generator within a head does not fire correctly or does not fire at all, resulting in a ribbon not being heated to a temperature necessary to transfer ink to the substrate.

The laser marking system of the present subject matter, a combination of a feeding system, an indexing system, and a laser-marking system including a plurality of inspection components to produce marked pre-cut sheets, pre-formed pouches, empty trays, and pre-lidded trays having complete labels without the use of a consumable ink component.

The laser marking system of the present subject matter also allows for, and is programmable to mark, multiple components to be single color marked within a single index length, and for a single or for multiple components (sheet, pouch, or tray) to be marked over multiple index lengths up to and including a 96-inch length. The system of the present subject matter also allows for both manual and automatic “On Demand” feeding, including indexing and marking of multiple lanes of components in a programmed index length, further including multiple configurations of uniformly shaped components (round, rectangular, and square) and non-uniform substrate shapes (long and/or narrow with or without side projections) with non-uniform height variations up to 20 millimeters without degradation of marked characters and/or graphics (if present). Such an allowance is provided since a laser head is typically mounted about 1 meter away from a substrate to be marked and has a wide focal distance variation capability of about +/−10 millimeters. Laser marking systems disclosed herein, coupled with an inspection system, provide sequential serialization of component marking within a product lot. Systems of the present subject matter also advantageously enable acceptance of components meeting programmed marking criteria. Systems of the present subject matter also enable rejection and segregation of defective components not meeting the programmed marking criteria.

Various methods described in detail herein have the capability to provide multiple lines of marks including barcodes (e.g., 1D and/or 2D barcodes) at relatively fast rates. Some implementations can, for instance, mark 500 characters with an 8-to 16-point font type, a 2D barcode, and human readable identification characters in the polymer material within 5 seconds, 4 seconds, 3 seconds, 2 seconds, or 1 second. In exemplary methods, a 2D barcode can be marked with a marking quality with an ISO/IEC 15415:2011 symbol grade of at least 2.0, 3.0, or 4.0 for an aperture, light, and angle or a February 2011 ANSI grade of at least “C”, “B”, or “A” per 2015 2D Barcode Verification Process Implementation Guidelines pursuant to GS1 Data Matrix Guideline Release 2.5.1, Ratified, January 2018. In certain instances, the barcode can meet the ISO/IEC 15415:2011 standards for one, all, or any combination of individual criteria consisting of decode, symbol-contrast, axis non-uniformity, modulation, grid non-uniformity, unused-error correction, fixed pattern damage, and print growth. For the criteria of symbol contrast, a result of 30 to 60% contrast can yield a 4.0 or “A” grade. Alternatively (or additionally), the barcode can meet the May 19, 2015, American Standard AS 9132. In some instances, the barcode can meet the May 19, 2015, American Standard AS 9132 standards for one, all, or any combination of the individual criteria of angle of distortion, filled cells, center point discrepancy, elongation, number of dots per element, and quiet zone. Alternatively (or additionally), the barcode can meet ISO/IEC TR 29158:2020 Direct Part Mark: Quality Guideline. In some instances, the barcode can meet ISO/IEC TR 29158:2020 standards for one, all, or any combination of the individual criteria of decode, symbol contrast, axis non-uniformity, modulation, grid non-uniformity, unused error correction, fixed pattern damage, and print growth. Alternatively (or additionally), the barcode can meet ISO/IEC TR 29158:2020 standards for individual criteria of modulation within a cell and/or minimum reflectance.

The above-described embodiments of the present subject matter are presented for purposes of illustration and not for purposes of limitation. While these embodiments have been described with reference to an assortment of preferred embodiments, a person of ordinary skill in the art (“POSITA”) will recognize that the present subject matter can be embodied in many forms without departing from the spirit of the present subject matter. Furthermore, a POSITA would understand that the present subject matter is not to be limited by the foregoing illustrative details, but rather is defined by the appended claims.

I claim:

1. A method of permanently marking a polymer material containing an opacification material, wherein the method comprises:
providing a polymer material containing an opacification material;
providing a laser system, wherein the laser system comprises a pulsed 352 nm to 355 nm ultraviolet laser with an average output power of 4 to 55 W; and
marking the polymer material with the pulsed 352 nm to 355 nm ultraviolet laser system at a minimum scan speed of 5 meters/second and a minimum pulse frequency of 30 KHz to produce a laser mark in or on the polymer material,
wherein no decomposition of the polymer material is detected in the laser mark after spectrometric analysis, and
wherein the opacification material is CaCO3 and/or a pigment.

2. The method of claim 1, wherein the laser system is capable of marking 500 characters in 10 to 15 point font, a 2D barcode, and human readable identification characters in the polymer material within 5 seconds.

3. The method of claim 2, wherein the laser system can mark the 500 characters, the 2D barcode, and the human readable identification characters in the polymer material within 3 seconds.

4. The method of claim 1, wherein the laser system can mark a 2D barcode in the polymer material.

5. The method of claim 4, wherein the 2D barcode has a marking quality with an ISO/IEC 15415:2011 symbol grade of at least 2.0, 3.0, or 4.0 for an aperture, light, and angle or a February 2011 ANSI grade of at least C, B, or A pursuant to the 2015 2D Barcode Verification Process Implementation Guideline per GS1 DataMatrix Guideline Release 2.5.1, Ratified, January 2018.

6. The method of claim 4, wherein the 2D barcode meets ISO/IEC 15415:2011 standards for one or more criteria selected from the group consisting of decode, symbol contrast, axis nonuniformity, modulation, grid nonuniformity, unused error correction, fixed pattern damage, and print growth.

7. The method of claim 4, wherein the 2D barcode meets May 19, 2015, American Standard AS 9132.

8. The method of claim 4, wherein the 2D barcode meets May 19, 2015, American Standard AS 9132 standards for one or more criteria selected from the group consisting of angle of distortion, filled cells, center point discrepancy, elongation, number of dots per element, and quiet zone.

9. The method of claim 4, wherein the 2D barcode meets ISO/IEC TR 29158:2020 Direct Part Mark Quality Guidelines.

10. The method of claim 4, wherein the 2D barcode meets ISO/IEC TR 29158:2020 standards for one or more criteria selected from the group consisting of decode, symbol contrast, axis nonuniformity, modulation, grid nonuniformity, unused error correction, fixed pattern damage, and print growth.

11. The method of claim 4, wherein the 2D barcode meets ISO/IEC TR 29158:2020 standards for individual criteria of modulation within a cell and/or minimum reflectance.

12. The method of claim 1, wherein the polymer material comprises spunbonded polyolefin or hydro entanglement generated polyolefin fibrous sheeting.

13. The method of claim 1, wherein the polymer material comprises a polyolefin selected from the group consisting of a high density polyethylene and a polypropylene.

14. The method of claim 1, wherein the polymer material comprises a solid polymer sheeting.

15. The method of claim 1, wherein the polymer material comprises polycarbonate, polyethylene terephthalate, acrylonitrile butadiene styrene, or polyvinyl chloride.

16. A polymer-marking system configured to permanently mark a polymer material containing an opacification material, wherein the polymer-marking system comprises:
a laser system comprising a pulsed 352 nm to 355 nm ultraviolet laser of average output power of 4 to 55 W, wherein the laser system has a marking field, wherein the laser system operates at a minimum scan speed of 5 meters/second and a minimum pulse frequency of 30 KHz for producing within the marking field a laser mark in or on the polymer material; and
a packaging machine in operational communication with the laser system, wherein the packaging machine is adapted and configured to hold a portion of a polymer material containing an opacification material within the marking field of the pulsed 352 nm to 355 nm ultraviolet laser system for a predetermined amount of time for producing a laser mark on the polymer material in the marking field,
wherein, upon receiving a signal from the packaging machine, the laser system is adapted and configured to laser mark the portion of the polymer material containing the opacification material within the marking field of the laser system within the predetermined amount of time for producing the laser mark on the polymer material in the marking field,
wherein no decomposition of the polymer material is detected in the laser mark after spectrometric analysis,
wherein, upon receiving a signal from the laser system, the packaging machine is adapted and configured to feed the laser marked portion out of the marking field of the laser system and feed a first successive portion of a plurality of successive portions of the polymer material containing the opacification material into the marking field of the laser system,
wherein the laser system is adapted and configured to mark each successive portion of the plurality of successive portions of the polymer material containing the opacification material,
wherein the packaging machine is adapted and configured to feed each successive laser marked portion of the polymer material out of the marking field of the laser system for a predetermined number of cycles, and
wherein the opacification material is CaCO3 and/or a pigment.

17. The polymer-marking system of claim 16, wherein the predetermined amount of time is 4 seconds or less.

18. The polymer-marking system of claim 16, wherein the number of cycles is at least 5 cycles.

19. The polymer-marking system of claim 16, wherein the number of cycles ranges from 1 to about 12 cycles.

20. The polymer-marking system of claim 16, wherein the number of cycles ranges from about 5 to about 15 cycles.

21. The polymer-marking system of claim 16, further including a temperature control system comprising a liquid coolant chilling system adapted and configured to controllably maintain a predetermined operational temperature for the laser system.

22. The polymer-marking system of claim 16, wherein the pulse frequency ranges from about 30 to about 50 KHz.
